(19) United States
(12) Patent Application Publication
(10) Pub. No.: US 2004/0210525 A1
(43) Pub. Date: Oct. 21, 2004

(54) Billing system for verifying billing information

(76) Inventor: Don E. Campbell, (US)

Correspondence Address: R. William Graham, 22 S. St. Clair St., Dayton, OH, 45402, US

(21) Appl. No.: 10/414,728

(22) Filed: Apr. 16, 2003

(51) Int. Cl. G06F 17/60

(52) U.S. Cl. 705/40

(57) ABSTRACT

A billing system for accurately verifying billing information provided by a party for purposes of engaging the party as a client and assuring that predetermined charges are properly authorized by the client includes a computer based device which includes operating software, billing and verification software operably associated therewith. The billing and verification software is operably associated with a telephone service provider database, wherein the telephone service provider database includes a data listing of telephone numbers each having an associated street address and party name, and the billing and verification software is capable of receiving billing information data which is provided by the party and comparing the provided billing information data with the data listing of telephone numbers, addresses and names and generating a signal indicative of one of confirming and not confirming provided billing information data. A method employing the same is disclosed.

### BACKGROUND OF THE INVENTION

1. Field of the Invention

The present invention relates to a billing system for verifying billing information. More particularly, the present invention relates to a billing system for accurately verifying a party's billing information which is provided for purposes of engaging a party as a client and assuring that charges are properly authorized by such party.

2. Background of the Invention

Information relating to a particular party is typically obtained when entering a business relationship between two contracting parties. A variety of ways exist to verify such party's information for purposes of billing, such as person's identification, including personal ID's issued by various government agencies, credit cards, licenses, etc. Typically, in a retail setting, when purchasing goods or services, an identifying card or the like presented along with a form of payment, e.g. cash, credit, or check.

This is often not the case with hospitals which frequently encounter situations of admitting a person as a patient. Hospitals often rely only on the billing information given by the person needing admission due to reasons of urgency, rule or policy. Consequently, instances occur where there are errors in patient billing information.

After admittance, a patient is typically placed in a room within the hospital. The room is equipped with services such as local and long distance telephone service and television service. These non-medical costs are typically billed to the patient using the provided patient billing information, as opposed to reimbursement via medical insurance. Accordingly, if false or incorrect patient billing information is provided, these costs are generally not recovered.

In cases where false or incorrect information is provided by the patient, costs associated with the patient's care and stay in the hospital are not paid which contributes to increasing cost of medical care. Like all businesses, hospitals are in a competitive environment in which they pay closer attention to profitability.

The present invention offers a billing system which solves or at least reduces the impact of the above-identified problems and other problems associated with hospitals.

### SUMMARY OF THE INVENTION

An object of the present invention is to aid in obtaining accurate personal billing information.

Yet another object of the present invention is to provide a billing system for services provided.

Another object of the present invention is to provide for a billing system in a hospital.

Another object of the invention is to provide for a billing system which increases recovery of telephone and television expenses attributed to a patient.

Still another object of the present invention is to prevent fraud which occurs during patient admittance.

Another object is to provide automated billing of telephone charges and television charges.

It is an object to reduce healthcare costs.

An additional object of the present invention is to provide a billing system which will reduce the amount of administrative collection work.

Accordingly, one embodiment of the present invention is directed to a billing system which includes billing and verification software for accurately verifying billing information provided by a party for purposes of engaging the party as a client and assuring that predetermined charges are properly authorized by the client. The billing system includes a computer based device which has operating software, billing and verification software operably associated therewith. The billing and verification software is operably associated with a telephone service provider database, wherein the telephone service provider database includes a data listing of telephone numbers having associated street addresses and associated names. The billing and verification software is capable of receiving provided billing information data and comparing the provided billing information data with the data listing of telephone numbers, addresses and names and generating a signal indicative of one of confirming or not confirming provided billing information data.

Further, upon confirming the provided billing information data, the billing and verification software authorizes a predetermined type of charge to be made by the party using the provided billing information data. In one embodiment, the data listing of telephone numbers is characterized as a listing of parties' telephone numbers, names, and addresses having an established account with a telephone service provider. The billing and verification software is equipped to bill the charges of the predetermined type through the established account for such patty.

These and various other advantages and features of novelty which characterize the invention are pointed out with particularity in the claims annexed hereto and forming a part hereof However, for a better understanding of the invention, its advantages and objects attained by its use, reference should be had to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram of an embodiment of the present invention.

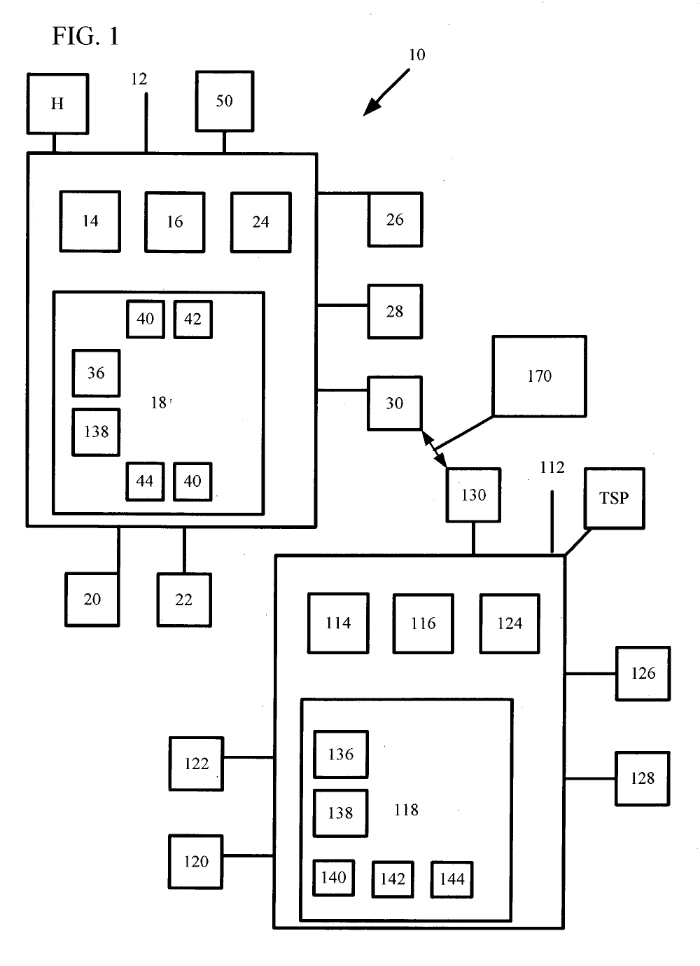

### DETAILED DESCRIPTION

Referring now to the drawing, the billing system for accurately verifying billing information provided by a party for purposes of engaging the party as a client and assuring that charges of a predetermined type are properly authorized by the client is generally referred to by the numeral 10. The system 10 includes a computer and which can include and is capable of running standard operating system software such as Windows, Linux, or Unix.

The system 10 can include a conventional computer 12 having a central processor (CPU) 14, random memory 16, permanent memory 18 (e.g., hard or fixed disk, optical disk, magneto-optical disk, or flash memory), and can include a keyboard 20, a mouse 22 (or like pointing device), a clock 24 and a display or screen device 26, otherwise known in the art to lend functionality to the computer 12. Processor 14 is operably associated with memory 16 for storing frequently accessed information. One or more input/output device(s) 28, such as a printer can be included. The computer 12 can preferably include a communication link 30 which can be a LAN, WAN, modem connection or other communication line, for example. Operably residing on the computer 12 is operating system software 36 and can be, for example, of a type described above or is known in the art. The operating software 36 is preferably stored in memory 18, and can include a one or more application programs as is known in the art.

Another computer 112 can be provided which has a central processor (CPU) 114, random memory 116, permanent memory 118, and can include a keyboard 120, a mouse 122, a clock 124 and a display or screen device 126, input/output device(s) 128, and a communication link 130, for example. Similarly, residing on the computer 112 is operating software 136 and includes a one or more applications as above. It should be noted that the invention can be modified, e.g., to add or delete devices, such as device 28, so long as the ability to perform the intended objectives of the invention can be carried out.

By way of example, the computer 12 can be located at a service provider's site, such as a hospital H, and the computer 112 can be remotely located site, e.g., at a telephone service provider site TSP. Billing and verification software 138 is operably associated with a telephone service provider database 140 which is shown here on a memory 118, but could be remotely located on another computer or additionally on computer 12 and work in cooperation with such software 138. The telephone service provider database 140 includes a data listing 142 of telephone numbers each having associated street addresses and associated names.

The billing and verification software 138 is capable of receiving billing information data 40 which is shown here, by way of example, on computer 12 and comparing the provided billing information data 40 with the data listing 142 of telephone numbers, addresses and names in the telephone service provider database 140. In this example, the billing and verification software 138 generates and communicates a signal to the computer 12 indicative of one of confirming or not confirming provided billing information data 40.

Upon confirming the provided billing information 40, the billing and verification software 138 authorizes predetermined charges to be made by the party using the provided billing information 40. In a preferred embodiment, each listed telephone number in the data listing 142 is on an established account with a telephone service provider TSP, the billing software 138 is equipped to bill the predetermined charges through the established account.

It is noted that the billing and verification software 138 can be operatively residing on either or both of the computers 12 and 112. It is further contemplated that the billing and verification software 138 could be web-based and that browser technology can be employed to employ the use of the software 138. Thus, the location of the billing software 138 can be so situated to carry out the invention.

The billing and verification software 138 is capable of associating, logging and storing of billing information data 40 into a client data file 42 via a client screen which displays client name field, contact name field, street address field, city address field, state zip code field, country field, work, fax and home telephone fields and creates a unique identification for each client. Likewise, the billing and verification software 138 provides entry of service provider data 44 into a service provider data file 46 via a service provider screen having company name field, service provider name field, street address field, city address field, state zip code field, country field, work, fax and home telephone fields, predetermined types of charge fields and unique identification for the service provider is permitted and stored in the service provider data file 46. Further, the billing and verification software 138 provides for associating and accruing charges of predetermined types of services/goods obtained or used by a particular client to be billed and writing and storing such all accrued charges into a billing data file 144.

Upon initiation, the billing and verification software 138 provides displays a screen (e.g., a windows-based screen) on the monitor 26 prompting the service provider to enter the billing information data 40. If the service provider cancels the operation, billing software 138 provides for the screen to minimize, and also optionally provides for exiting of the billing software 138. Upon logging the billing information data 40, billing and verification software 138 performs a verification of the billing information data 40 by comparing against the data listing 142 in the database 140 and displays a screen confirming or not confirming the billing information data 40. If confirming, the billing and verification software 138 enables predetermined types of services/goods to be accrued through to the billing data file 144 as set forth above. In the case of telephone charges being a type of predetermined chargeable item, a telephone system 50, having a plurality of phones operably connected thereto, is operably connected to the computer 12 such that the billing and verification software 138 can automatically accrue telephone charges associated with a particular phone in the phone system 50 and associate the charges, with corresponding client data and service provider data into the billing data file 144. If not confirmed, billing and verification software 138 generates a call signal to an alternative billing mechanism 170 (such as a billing call center), wherein the alternative billing center 170 is equipped to handle credit card billing or other suitable billing arrangement between the client and the service provider.

The billing and verification software 138 is preferably continuously running to receive charges to the billing data file 144 and in turn, the billing and verification software 138 generates an invoice (by way of any suitable printing means) to the client on behalf of the service provider. Herein, the invoice generated would include listing the client data and service provider data with itemized call time data (i.e., services/goods provided).

The above described embodiment is set forth by way of example and is not for the purpose of limiting the present invention. It will be readily apparent to those skilled in the art that obvious modifications, derivations and variations can be made to the embodiment without departing from the scope of the invention. Accordingly, the claims appended hereto should be read in their full scope including any such modifications, derivations and variations.

What is claimed is:

1. A billing system for accurately verifying billing information provided by a party for purposes of engaging the party as a client and assuring that predetermined charges are properly authorized by the client, which includes:
a computer based device which includes operating software, billing and verification software operably associated therewith, and data input device wherein said billing and verification software is operably associated with one of a telephone service provider database and a credit service provider database, wherein said service provider database includes a data listing of telephone numbers each having an associated street address and party name, and said billing and verification software is capable of receiving billing information data which is one of orally and written provided by the party through said input device and comparing said provided billing information data with said data listing of telephone numbers, addresses and names of said service provider database and generating a signal indicative of one of confirming and not confirming provided billing information data.

2. The billing system of claim 1, wherein said billing and verification software authorizes a predetermined type of charge to be made by the part using the provided billing information data upon confirming said billing information data.

3. The billing system of claim 2, wherein said data listing of telephone numbers is characterized as a data listing of telephone numbers, names, and addresses having an established: account with a predetermined telephone service provider.

4. The billing system of claim 3, wherein said billing and verification software is equipped to bill said charge of said predetermined type through said established account for such party.

5. The billing system of claim 4, wherein said computer based device is employed at a hospital and operably connected to a telephone system at said hospital in a manner to permit said billing and verification software to accrue telephone charges as said predetermined type of charge.

6. The billing system of claim 1, wherein said computer based device is employed at a hospital and operably connected to a telephone system at said hospital in a manner to permit said billing and verification software to accrue telephone charges as said predetermined type of charge.

7. The billing system of claim 1, wherein said computer based device is employed at a hospital and operably connected to a television system at said hospital in a manner to permit said billing and verification software to accrue television charges as said predetermined type of charge.

8. The billing system of claim 4, wherein said computer based device is employed at a hospital and operably connected to a television system at said hospital in a manner to permit said billing and verification software to accrue television charges as said predetermined type of charge.

9. The billing system of claim 1, wherein said billing and verification software sends a signal to employ an alternative billing mechanism upon not confirming said billing information data.

10. A method of billing and verifying billing information provided by a party for purposes of engaging the party as a client and assuring that predetermined charges are properly authorized by the client, which includes the steps of:
entering one of orally and written provided billing information as billing information data through a data input device of a computer based device including operating software, and billing and verification software operably associated therewith, wherein said billing and verification software is operably associated with one of a telephone service provider database and a credit service provider database, wherein said service provider database includes a data listing of telephone numbers each having an associated street address and party name;
employing said billing and verification software to receive said billing information data and to compare said provided billing information data with said data listing of telephone numbers, addresses and names of said service provider database; and
further employing said billing and verification software to generate a signal indicative of one of confirming and not confirming provided billing information data.

11. The method of claim 10, which further includes employing said billing and verification software to authorize a predetermined type of charge to be made by the party using the provided billing information data upon confirming said billing information data.

12. The method of claim 11, wherein said data listing of telephone numbers is characterized as a data listing of telephone numbers, names, and addresses having an established account with a predetermined telephone service provider.

13. The method of claim 12, wherein said billing and verification software bills said charge of said predetermined type through said established account for such party.

14. The method of claim 10, wherein said billing and verification software sends a signal to employ an alternative billing mechanism upon not confirming said billing information data.

15. The method of claim 10, wherein said computer based device is employed at a hospital and operably connected to a telephone system at said hospital in a manner to permit said billing and verification software to accrue telephone charges as said predetermined type of charge.

16. The method of claim 13, wherein said computer based device is employed at a hospital and operably connected to a telephone system at said hospital in a manner to permit said billing and verification software to accrue telephone charges as said predetermined type of charge.

17. The method of claim 10, wherein said computer based device is employed at a hospital and operably connected to a television system at said hospital in a manner to permit said billing and verification software to accrue television charges as said predetermined type of charge.

18. The method of claim 13, wherein said computer based device is employed at a hospital and operably connected to a television system at said hospital in a manner to permit said billing and verification software to accrue television charges as said predetermined type of charge.
